(19) United States
(12) Patent Application Publication
(10) Pub. No.: US 2026/0221671 A1
(43) Pub. Date: Jul. 30, 2026

(54) RADIATING ELEMENTS HAVING CLOAKED FEED STALKS AND BASE STATION ANTENNAS INCLUDING SUCH RADIATING ELEMENTS

(71) Applicant: Outdoor Wireless Networks LLC, Richardson, TX (US)

(72) Inventors: Rakesh KALWANI, Gogol Margao (IN); Kumara Swamy KASANI, Godavarikahani (IN); Ligang WU, Suzhou, Jiangsu (CN)

(21) Appl. No.: 19/145,417

(22) PCT Filed: Jan. 3, 2024
(86) PCT No.: PCT/US2024/010094

§ 371 Date: Jul. 2, 2025

Related U.S. Application Data
(60) Provisional application No. 63/437,146, filed on Jan. 5, 2023.

(51) Int. Cl. H01Q 21/26; H01Q 9/28

(52) U.S. Cl. CPC H01Q 21/26; H01Q 9/285

(57) ABSTRACT

A cross-dipole radiating element includes a feed stalk having a base and a distal end that is positioned forwardly of the base, a first dipole radiator mounted at the distal end of the feed stalk, the first dipole radiator including a first dipole arm and a second dipole arm, and a second dipole radiator mounted at the distal end of the feed stalk, the second dipole radiator including a third dipole arm and a fourth dipole arm. The feed stalk includes a first ground line and a first signal trace that at least partially overlaps the first ground line. The first ground line comprises at least first, second and third widened conductive segments, where the first and second widened conductive segments are connected by a first narrowed conductive trace and the second and third widened conductive segments are connected by a second narrowed conductive trace.

### CROSS-REFERENCE TO RELATED APPLICATION

The present application claims priority to U.S. Provisional Application Ser. No. 63/437,146, filed Jan. 5, 2023, the entire content of which is incorporated herein by reference.

### BACKGROUND

The present invention generally relates to radio communications and, more particularly, to base station antennas for cellular communications systems and to radiating elements for such base station antennas

Cellular communications systems are well known in the art. In a cellular communications system, a geographic area is divided into a series of regions that are referred to as “cells” which are served by respective base stations. The base station may include one or more base station antennas that are configured to provide two-way radio frequency (“RF”) communications with mobile subscribers that are within the cell served by the base station. Typically, the base station antennas are mounted on a tower or other raised structure, with the radiation patterns (also referred to herein as “antenna beams”) that are generated by the base station antennas directed outwardly. In many cases, each cell is divided into a plurality of smaller regions in the horizontal or “azimuth” plane that are called “sectors.” In one common configuration, a hexagonally shaped cell is divided into three 120° sectors in the azimuth plane, and each sector is served by one or more “sector” base station antennas that generate antenna beams having azimuth Half Power Beamwidths (“HPBW”) of approximately 65°, which provides good coverage throughout the 120° sector. The antenna beams are generated by single column or multi-column phased arrays of radiating elements that are included in the antenna. The radiating elements are typically mounted to extend forwardly from a metal reflector that acts as a ground plane for the radiating elements and that acts to reflect rearwardly directed RF radiation emitted by the radiating elements back in the forward direction.

In order to accommodate the increasing volume of cellular communications, cellular operators have added cellular service in a variety of new frequency bands. In order to support service in these new frequency bands, most base station antennas are implemented as multiband antennas that have different arrays of radiating elements that support service in the different frequency bands. In order to further increase capacity, cellular operators are interested in increasing the number of arrays included in many base station antenna designs. Unfortunately, the radiating elements in the different arrays can interact with each other, which may make it challenging to add additional arrays to existing multi-band antennas while also meeting customer requirements relating to the size (and particularly the width) of the base station antenna.

### SUMMARY

Pursuant to embodiments of the present invention, cross-dipole radiating elements are provided that comprise a feed stalk having a base and a distal end that is positioned forwardly of the base; a first dipole radiator mounted at the distal end of the feed stalk, the first dipole radiator including a first dipole arm and a second dipole arm; and a second dipole radiator mounted at the distal end of the feed stalk, the second dipole radiator including a third dipole arm and a fourth dipole arm. The feed stalk includes a first ground line and a first signal trace that at least partially overlaps the first ground line. The first ground line comprises at least first, second and third widened conductive segments, where the first and second widened conductive segments are connected by a first narrowed conductive trace and the second and third widened conductive segments are connected by a second narrowed conductive trace.

In some embodiments, an average width of the first narrowed conductive trace may be less than half an average width of the first widened conductive segment.

In some embodiments, the feed stalk may further comprise a second ground line that comprises at least fourth, fifth and sixth widened conductive segments, where the fourth and fifth widened conductive segments are connected by a third narrowed conductive trace and the fifth and sixth widened conductive segments are connected by a fourth narrowed conductive trace. In some embodiments, the first ground line may extend forwardly along substantially an entire length of the feed stalk, and the first ground line may further comprise a first spur that extends toward the second ground line, and the second ground line may extend forwardly along substantially the entire length of the feed stalk, and the second ground line may further comprise a second spur that extends toward the first ground line. In some embodiments, an average width of the first spur may be less than an average width of the first widened conductive segment. In some embodiments, the first spur may extend from the second narrowed conductive trace.

In some embodiments, the respective lengths of the first through third widened conductive segments may vary by less than 25%.

In some embodiments, the first signal trace may fully overlap the first narrowed conductive trace and may fully overlap the second narrowed conductive trace.

In some embodiments, an average width of the second spur may be less than an average width of the fourth widened conductive segment, and the second spur may extend from the fourth narrowed conductive trace.

In some embodiments, the first single trace may include a first forwardly extending segment, a second transversely extending segment and a third rearwardly extending segment, where one of the first forwardly extending segment, the second transversely extending segment and the third rearwardly extending segment includes a meandered section. In some embodiments, the first forwardly extending segment may include the meandered section.

In some embodiments, the first narrowed conductive trace may include a meandered section.

In some embodiments, the feed stalk may comprise a feed stalk printed circuit board, and the first signal trace may be a first metallization pattern on a first side of the feed stalk printed circuit board and the first ground line may be a second metallization pattern on a second side of the feed stalk printed circuit board.

Pursuant to further embodiments of the present invention, cross-dipole radiating elements are provided that comprise a feed stalk having a base and a distal end that is positioned forwardly of the base; a first dipole radiator mounted at the distal end of the feed stalk, the first dipole radiator including a first dipole arm and a second dipole arm; and a second dipole radiator mounted at the distal end of the feed stalk, the second dipole radiator including a third dipole arm and a fourth dipole arm. The feed stalk includes a first ground line and a first signal trace, where the first signal trace comprises a first forwardly extending segment, a second transversely extending segment and a third segment. Moreover, one of the first forwardly extending segment, the second transversely extending segment and the third segment includes a meandered section.

In some embodiments, the meandered section may comprise at least one U-shaped section. In some embodiments, the first forwardly extending segment may include the meandered section.

In some embodiments, the first ground line may comprise first and second widened conductive segments that are connected by a first narrowed conductive trace. In such embodiments, an average width of the first narrowed conductive trace may be less than half an average width of the first widened conductive segment. The first narrowed conductive trace may include a meandered section.

In some embodiments, the first signal trace may fully overlap the first narrowed conductive trace.

In some embodiments, the feed stalk may comprise a feed stalk printed circuit board, and the first signal trace may be a first metallization pattern on a first side of the feed stalk printed circuit board and the first ground line may be a second metallization pattern on a second side of the feed stalk printed circuit board.

In some embodiments, the first ground line may extend along a longitudinal direction of the feed stalk printed circuit board and includes a first spur that extends along a transverse direction of the feed stalk printed circuit board.

In some embodiments, the first spur may extend from the first narrowed conductive trace.

In some embodiments, an average width of the first spur may be less than an average width of the first widened conductive segment.

Pursuant to additional embodiments of the present invention, cross-dipole radiating elements are provided that comprise a feed stalk having a base and a distal end that is positioned forwardly of the base; a first dipole radiator mounted at the distal end of the feed stalk, the first dipole radiator including a first dipole arm and a second dipole arm; and a second dipole radiator mounted at the distal end of the feed stalk, the second dipole radiator including a third dipole arm and a fourth dipole arm. The feed stalk includes a first ground line and a first signal trace. Additionally, the first ground line includes first and second widened conductive segments that are connected by a first narrowed conductive trace that includes a first meandered section.

In some embodiments, the first meandered section may comprise a U-shaped section.

In some embodiments, an average width of the first narrowed conductive trace may be less than half an average width of the first widened conductive segment.

In some embodiments, the first single trace may include a first forwardly extending segment, a second transversely extending segment and a third rearwardly extending segment, and one of the first forwardly extending segment, the second transversely extending segment and the third rearwardly extending segment may include a second meandered section.

In some embodiments, the first forwardly extending segment may include the second meandered section.

In some embodiments, the feed stalk may further comprise a second ground line that comprises at least third and fourth widened conductive segments that are connected by a second narrowed conductive trace.

In some embodiments, the first ground line may extend forwardly along substantially an entire length of the feed stalk, the first ground line may further comprise a first spur that extends toward the second ground line, and the second ground line may extend forwardly along substantially the entire length of the feed stalk, and the second ground line may further comprise a second spur that extends toward the first ground line.

In some embodiments, the first spur may extend from the first narrowed conductive trace.

In some embodiments, the first signal trace may at least partially overlap the first narrowed conductive trace and may fully overlap the second narrowed conductive trace.

In some embodiments, the third segment may be a rearwardly-extending segment.

Pursuant to still further embodiments of the present invention, base station antennas are provided that comprise a frequency selective surface; an array of lower-band radiating elements positioned forwardly of the frequency selective surface; and a multi-column array of higher-band radiating elements positioned rearwardly of the frequency selective surface. At least one of the lower-band radiating elements includes a pair of dipole radiators, a first feed cable and a second feed cable, where the first feed cable and the second feed cable extend forwardly from the frequency selective surface to directly attach to the respective first and second dipole radiators.

In some embodiments, a diameter of the first feed cable is less than 1.68 mm.

### BRIEF DESCRIPTION OF THE DRAWINGS

FIG. 1A is a schematic perspective view of a conventional cross-dipole radiating element.

FIG. 1B is a schematic side view of the conventional cross-dipole radiating element of FIG. 1A.

FIG. 2A is a schematic perspective view of a passive/active antenna system that includes a passive base station antenna that may be implemented using low-band radiating elements according to embodiments of the present invention.

FIG. 2B is a schematic front view of the passive/active antenna system of FIG. 2A with the radomes thereof omitted.

FIG. 3A is a schematic perspective view of a low-band radiating element according to embodiments of the present invention.

FIGS. 3B and 3C are schematic plan views of first and second major surfaces of a feed stalk printed circuit board included in the radiating element of FIG. 3A.

FIG. 3D is a schematic shadow plan view that illustrates the metallization on both sides of the feed stalk printed circuit board of FIGS. 3B and 3C.

FIG. 4A is a schematic perspective view of a low-band radiating element according to further embodiments of the present invention.

FIGS. 4B and 4C are schematic plan views of first and second major surfaces of a feed stalk printed circuit board included in the radiating element of FIG. 4A.

FIG. 4D is a schematic shadow plan view that illustrates the metallization on both sides of the feed stalk printed circuit board of FIGS. 4B and 4C.

FIG. 5 is a schematic side view of an array of radiating elements according to additional embodiments of the present invention.

### DETAILED DESCRIPTION

As discussed above, it can be challenging to provide relatively narrow base station antennas that have arrays of radiating elements that operate in several different frequency bands. This is particularly true if the antenna includes a beamforming array, such as an eight column array of high-band radiating elements that is coupled to a beamforming radio. The width of a multi-band base station antenna may be reduced by decreasing the separation between adjacent arrays of radiating elements. However, as the separation between arrays is reduced, increased coupling between the radiating elements of the different arrays occurs, which may, for example, result in “scattering” of the RF signals at one frequency band by the radiating elements of other frequency bands. Scattering is undesirable as it may change the shape of the antenna beam in both the azimuth and elevation planes, and the changes in the shape of the antenna beam may vary significantly with frequency. This may make it difficult to compensate for the effects of scattering using other techniques. For example, scattering tends to negatively impact the beamwidth, beam shape, pointing angle, gain and front-to-back ratio of the antenna beams in the azimuth plane.

Scattering primarily occurs when a conductive structure of a first frequency band radiating element has an electrical length that makes the structure resonant in the operating frequency band of a nearby radiating element that operates in a second (different) frequency band. For example, most modern base station antennas include both “low-band” radiating elements that operate in the 617-960 MHz frequency band or a portion thereof and “mid-band” radiating elements that operate in the 1427-2690 MHz frequency band or a portion thereof. If cross-dipole radiating elements are used, each low-band dipole radiator typically is implemented as a pair of dipole arms that each have an electrical length that is approximately ¼ a wavelength (herein “the center wavelength”) that corresponds to the center frequency of the operating frequency band for the low-band radiating element. Thus, each dipole radiator has an electrical length that is approximately ½ the “center” wavelength.

Since the mid-band frequency range encompasses frequencies that are twice the frequencies in the low-band frequency range, the electrical length of each low-band dipole arm may be approximately ½ a wavelength of RF signals transmitted in the lower portion of the mid-band operating frequency band. As such, RF energy transmitted by the mid-band radiating elements (particularly when the mid-band radiating elements operate in the lower portion of the mid-band operating frequency band) may couple (scatter) to the dipole arms of nearby low-band radiating elements. As described above, this coupling can distort the antenna beams generated by an array of mid-band radiating elements. Similar distortion can occur if RF energy emitted by so-called high-band radiating elements (which typically operate in a portion of the 3.1-5.8 GHz frequency band) couples to the low-band radiating elements or to the mid-band radiating elements. The radiating elements according to embodiments of the present invention may be designed to be substantially transparent to nearby radiating elements that operate in other frequency bands so that scattering is largely eliminated. Radiating elements that are designed to suppress such scattering are commonly referred to as “cloaking” radiating elements.

Cloaking radiating elements are known in the art. For example, U.S. Pat. No. 9,570,804 discloses a low-band radiating element that includes dipole arms that are formed as a series of RF chokes. The RF chokes suppress the formation of mid-band current on the low-band dipole arms in order to render the low-band radiating element substantially transparent to mid-band RF energy. U.S. Pat. Nos. 10,439,285 and 10,770,803 each disclose low-band radiating elements that include dipole arms that are formed as a series of widened segments that are coupled by narrow inductive segments, which may be implemented as small, meandered trace segments on a printed circuit board. In each case, the narrow inductive segments act as high impedance elements for RF energy in the mid-band frequency range, rendering the low-band radiating elements substantially transparent to RF energy in that frequency range. As another example, U.S. Pat. No. 11,018,437 discloses a low-band radiating element that includes two dipole arms that are substantially transparent to mid-band RF energy and another two dipole arms that are substantially transparent to high-band RF energy. Additional cloaking radiating element designs are disclosed in Chinese Patent No. CN 112787061A, Chinese Patent No. CN 112164869A, Chinese Patent No. CN 112290199A, Chinese Patent No. CN 111555030A, Chinese Patent No. CN 112186333A, Chinese Patent No. CN 112186341A, Chinese Patent No. CN 112768895A, Chinese Patent No. CN 112821044A, Chinese Patent No. CN 213304351U, Chinese Patent No. CN 112421219A, and PCT Publication WO 2021/042862.

The above-described cloaking radiating elements are designed so that the RF energy emitted by a higher-band radiating element tends to not form higher-band currents on the dipole arms of a nearby lower-band radiating element. The present invention is based, in part, on the realization that the feed stalks of the lower-band radiating elements may also cause scattering. A feed stalk of a cross-dipole radiating element refers to a structure that feeds RF signals to and from the dipole arms of the radiating element. In most case, the dipole arms are mounted on the distal (forward) end of the feed stalk, and the base (rear) end of the feed stalk is mounted on the reflector of the base station antenna or on a feed board printed circuit board that is mounted on the reflector.

The feed stalk of a radiating element typically has a length that is about ¼ of the center wavelength so that RF radiation that is emitted rearwardly by the dipole radiators will reflect off of the reflector and be in-phase with the RF radiation emitted in the forward direction by the dipole arms (since the phase of the RF radiation will change by 90° as it travels ¼ of the center wavelength from the dipole arm to the reflector, will change by another 180° as it reflects off of the reflector, and will change by an additional 90° as it travels ¼ of the center wavelength back to the dipole radiator). The feed stalks typically include metal structures that extend along the length of the feed stalk, and hence these metal structures may have a length that is about ¼ of the center wavelength of the radiating element. As such, the feed stalks of lower-band radiating elements may also cause scattering with respect to RF radiation emitted by nearby higher-band radiating elements. While the amount of scattering caused by the feed stalks of the lower-band radiating elements tends to be much lower than the scattering caused by non-cloaked lower-band dipole arms, the emission levels may still be significant enough to distort the higher-band antenna beams. This is particularly true when the higher-band radiating elements are mounted directly behind the lower-band radiating elements.

Pursuant to embodiments of the present invention, cross-dipole radiating elements are provided that have cloaked feed stalks. The feed stalks included in the radiating elements according to embodiments of the present invention may have cloaked ground lines and/or cloaked signal traces. For example, one or both of the ground lines and/or the signal traces on the feed stalk may be implemented as a series of widened conductive segments that are interconnected by narrowed (and possibly meandered) conductive traces. Each narrowed conductive trace may create a high impedance for currents that are, for example, at frequencies in the operating frequency band of a nearby higher-band radiating element. The radiating elements according to embodiments of the present invention may be included in multi-band base station antennas, and may reduce the amount of interaction between the arrays in the different frequency bands. Base station antennas that include the radiating elements according to embodiments of the present invention may be used, for example, as sector antennas in the above-described cellular communications systems.

In some embodiments, cross-dipole radiating elements are provided that include a feed stalk having a base and a distal end that is positioned forwardly of the base, and first and second dipole radiators that are mounted at the distal end of the feed stalk. The feed stalk includes a first ground line and a first signal trace that at least partially overlaps the first ground line. The first ground line and the first signal trace may, for example, be implemented on a feed stalk printed circuit board. The first ground line comprises at least first, second and third widened conductive segments, where the first and second widened conductive segments are connected by a first narrowed conductive trace and the second and third widened conductive segments are connected by a second narrowed conductive trace.

In other embodiments, cross-dipole radiating elements are provided that include a feed stalk and first and second dipole radiators that are mounted at a distal end of the feed stalk. The feed stalk includes a first ground line and a first signal trace. The first signal trace comprises a first forwardly extending segment, a second transversely extending segment and a third segment. Moreover, one of the first forwardly extending segment, the second transversely extending segment and the third segment includes a meandered section.

In still other embodiments, cross-dipole radiating elements are provided that include a feed stalk and first and second dipole radiators that are mounted at a distal end of the feed stalk. The feed stalk includes a first ground line and a first signal trace, where the first ground line includes first and second widened conductive segments that are connected by a first narrowed conductive trace. The first narrowed conductive trace includes a first meandered section.

In the above-discussed embodiments, an average width of the first narrowed conductive trace may be less than half an average width of the first widened conductive segment. Moreover, the feed stalk may further include a second ground line that comprises a plurality of widened conductive segments that are connected by one or more additional narrowed conductive traces. In such embodiments, the first and second ground lines may extend forwardly along the feed stalk, and the first ground line may further include a first spur that extends toward the second ground line, and the second ground line may line further include a second spur that extends toward the first ground line. The first and/or second spur may extend from respective ones of the narrowed conductive traces.

Before discussing the radiating elements according to embodiments of the present invention it is helpful to discuss the design and operation of a representative conventional low-band radiating element for a base station antenna.

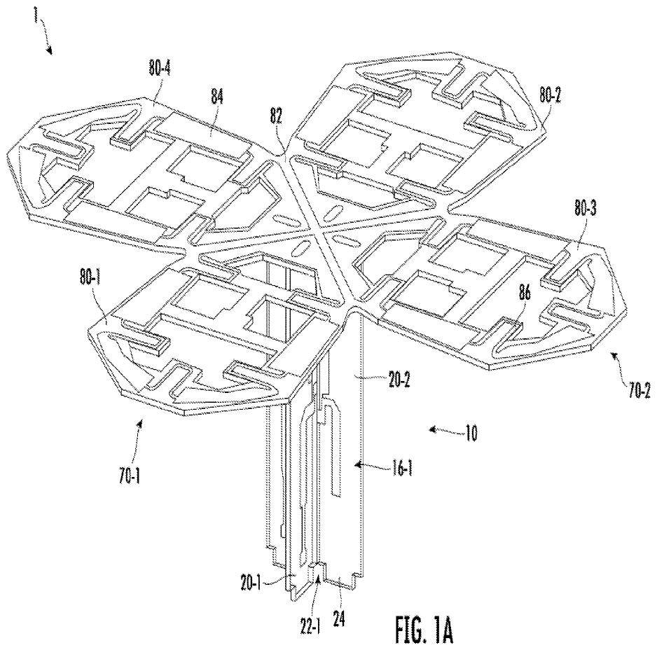

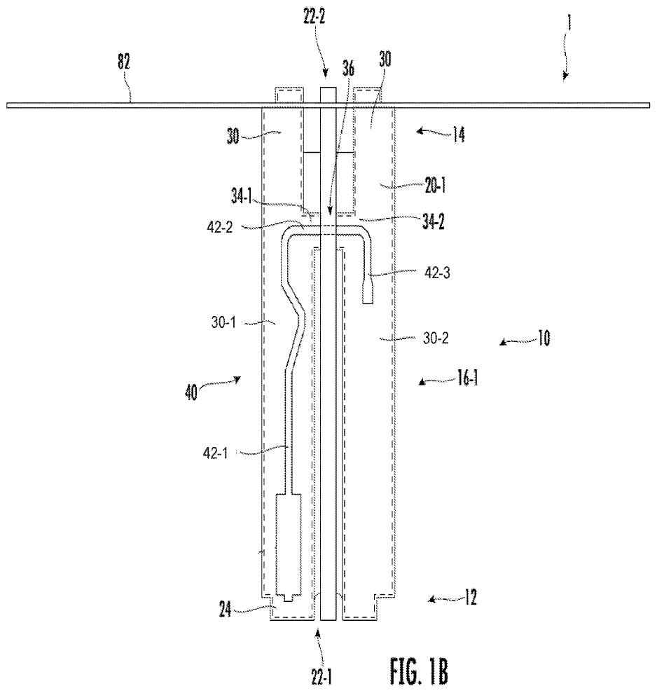

FIG. 1A is a perspective view of a conventional low-band cross-dipole radiating element 1. FIG. 1B is a shadow side view of cross-dipole radiating element 1 that illustrates the metallization patterns on a first feed stalk printed circuit board 20-1 of radiating element 1. In FIG. 1B, the solid lines are the metallization patterns on the first side of feed stalk printed circuit board 20-1 and the dashed lines are the metallization patterns on the second (opposed) side of feed stalk printed circuit board 20-1. In FIG. 1B, only a side surface of a second feed stalk printed circuit board 20-2 is visible as the major surfaces of feed stalk printed circuit board 20-2 are perpendicular to the viewing angle. It should be noted that herein like elements may be referred to individually by their full reference numeral (e.g., feed stalk printed circuit board 20-2) and may be referred to collectively by the first part of their reference numeral (e.g., the feed stalk printed circuit boards 20).

As shown in FIG. 1A, the conventional cross-dipole radiating element 1 includes a feed stalk 10 and a pair of dipole radiators 70-1, 70-2. The feed stalk 10 comprises first and second feed stalk printed circuit boards 20-1, 20-2. Each feed stalk printed circuit board 20-1, 20-2 includes a respective RF transmission line structure 16-1, 16-2 that carry RF signals between first and second feed transmission lines (not shown) for the radiating element 1 and the respective cross-dipole radiators 70-1, 70-2. Each feed transmission line may comprise, for example, a coaxial cable or a microstrip transmission line on a feed board printed circuit board. The feed transmission lines carry RF signals between the radiating element 1 and other components of a base station antenna that includes radiating element 1.

Referring to both FIGS. 1A and 1B, the feed stalk 10 has a base 12 and a distal end 14. The distal end 14 is positioned forwardly of the base 12. The first feed stalk printed circuit board 20-1 includes a slit 22-1 that extends forwardly from the base 12 of the feed stalk 10, and the second feed stalk printed circuit board 20-2 includes a slit 22-2 that extends rearwardly from the distal end 14 of the feed stalk 10. Feed stalk printed circuit boards 20-1 and 20-2 are arranged perpendicular to each other with the slit 22-2 in feed stalk printed circuit board 20-2 received within the slit 22-1 in feed stalk printed circuit board 20-1 so that the two mated feed stalk printed circuit boards 20-1, 20-2 have a cross-shape when viewed from the front.

Rear portions of each feed stalk printed circuit board 20 may include projections 24 that are inserted through slits in a feed board printed circuit board (not shown). Metallized pads on the projections 24 may be soldered to metallized pads on the feed board printed circuit board to mechanically mount the radiating element 1 on the feed board printed circuit board and to electrically connect the RF transmission line structures 16-1, 16-2 on the feed stalk 10 to the feed transmission lines on the feed board printed circuit board.

The dipole radiators 70-1, 70-2 are positioned at the distal end 14 of the feed stalk 10 and may be (and typically are) physically mounted on the distal end 14 of the feed stalk 10. The first dipole radiator 70-1 extends along a first axis and the second dipole radiator 70-2 extends along a second axis that is generally perpendicular to the first axis. The first dipole radiator 70-1 includes first and second dipole arms 80-1, 80-2, and the second dipole radiator 70-2 includes third and fourth dipole arms 80-3, 80-4. The dipole radiators 70-1, 70-2 may be formed in a dipole radiator printed circuit board 82. The dipole arms 80 are cloaking dipole arms that are formed as a series of widened metal segments 84 that are interconnected by narrow metal traces 86. The dipole radiators 70-1, 70-2 are shown as having an elongated “FIG. 8” shape where each dipole arm 80 is formed as a loop. A wide variety of dipole arms are known in the art, including dipole arms that have many different shapes or that are formed in different ways (e.g., using sheet metal). It will be appreciated that the radiating elements according to embodiments of the present invention that have the feed stalk designs disclosed herein may have any appropriate dipole arm design, including dipole arms having any shape, that are formed, for example, in any of the ways discussed above.

Dipole arms 80-1 and 80-2 of first dipole radiator 70-1 are center fed by the first RF transmission line structure 16-1 on the first feed stalk printed circuit board 20-1 and radiate together at a first polarization. In the depicted embodiment, the first dipole radiator 70-1 is designed to transmit and receive signals having a slant +45° linear polarization. Dipole arms 80-3 and 80-4 of second dipole radiator 70-2 are center fed by the second RF transmission line structure 16-2 on the second feed stalk printed circuit board 20-2 and radiate together at a second polarization that is orthogonal to the first polarization. The second dipole radiator 70-2 is designed to transmit and receive signals having a slant −45° linear polarization.

As shown in FIG. 1B, a twin line transmission line structure is formed on the second side of feed stalk printed circuit board 20-1. The twin line transmission line structure comprises first and second ground lines 30-1, 30-2 that are implemented as first and second metallized regions that extend from the base 12 of feed stalk 10 to the distal end 14 thereof. Each ground line 30-1, 30-2 is coupled to the ground conductor of the first feed transmission line for radiating element 1 (not shown). The connections between the first and second ground lines 30-1, 30-2 and the ground conductor of the first feed transmission line may be at the base 12 of feed stalk 10. The first and second ground lines 30-1, 30-2 may each have an electrical length of about ¼ the center wavelength of radiating element 1.

A signal trace 40 is formed on the first side of feed stalk printed circuit board 20-1. The signal trace 40 is coupled to the signal conductor of the feed transmission line that feeds the feed stalk printed circuit board 20-1. The signal trace 40 extends forwardly from the base 12 of feed stalk 10 and travels about two-thirds of the way toward the distal end 14 of feed stalk 10. The signal trace 40 then goes through a first 90° turn to extend transversely across the first side of feed stalk printed circuit board 20-1. Finally, the signal trace 40 goes through a second 90° turn to extend rearwardly toward the base 12 of feed stalk 10.

The signal trace 40 includes a forwardly extending segment 42-1, a transversely extending segment 42-2, and a rearwardly extending segment 42-3. The forwardly extending segment 42-1 overlaps the first ground line 30-1. Herein, two elements on a printed circuit board (or an equivalent structure) “overlap” if an axis that is perpendicular to a major surface of the printed circuit board intersects both elements. The transversely extending segment 42-2 extends from the end of the forwardly extending segment 42-1, to cross over a gap 34 (i.e., an unmetallized region) that is provided between the first and second ground lines 30-1, 30-2. The transversely extending segment 42-2 overlaps portions of both the first ground line 30-1 and the second ground line 30-2. The rearwardly extending segment 42-3 extends at a right angle from the end of the transversely extending segment 42-2 back toward the base 12 of feed stalk 10. The rearwardly extending segment 42-3 overlaps the second ground line 30-2.

As discussed above, pursuant to embodiments of the present invention, cross-dipole radiating elements are provided that have cloaked feed stalks that may be substantially transparent to RF energy in the operating frequency bands of one or more nearby higher frequency band radiating elements. The metallization of the feed stalks used in the radiating elements according to embodiments of the present invention may have cloaking structures that provide the improved cloaking performance. The improved cloaking performance may improve the peak directivity for nearby higher-band radiating elements.

The discussion of the cross-dipole radiating elements according to embodiments of the present invention below will focus on low-band radiating elements that are designed to be cloaking with respect to nearby mid-band and/or high-band radiating elements as an example. However, it will be appreciated that the techniques disclosed herein may be used, for example, to provide mid-band radiating elements that are cloaking with respect to nearby high-band radiating elements or in any other appropriate application. Thus, while the radiating elements according to embodiments of the present invention are described below as being low-band radiating elements, it will be appreciated that they may alternatively be reduced in size to operate as mid-band or high-band radiating elements.

Before describing example embodiments of the radiating elements of the present invention, an example base station antenna in which the radiating elements according to embodiments of the present invention may be used will first be described.

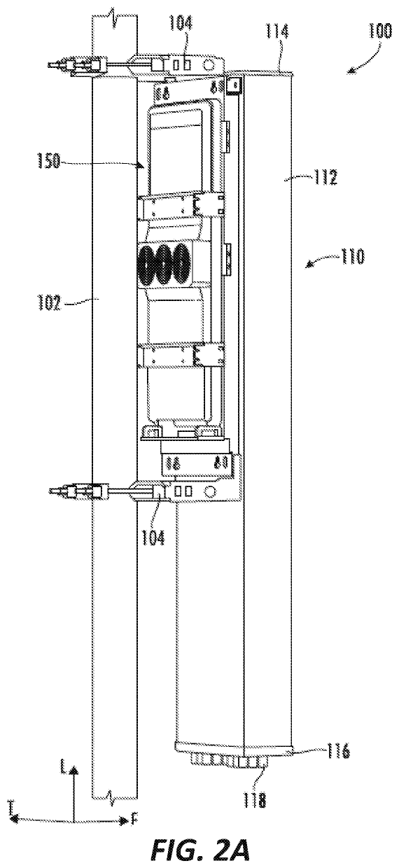

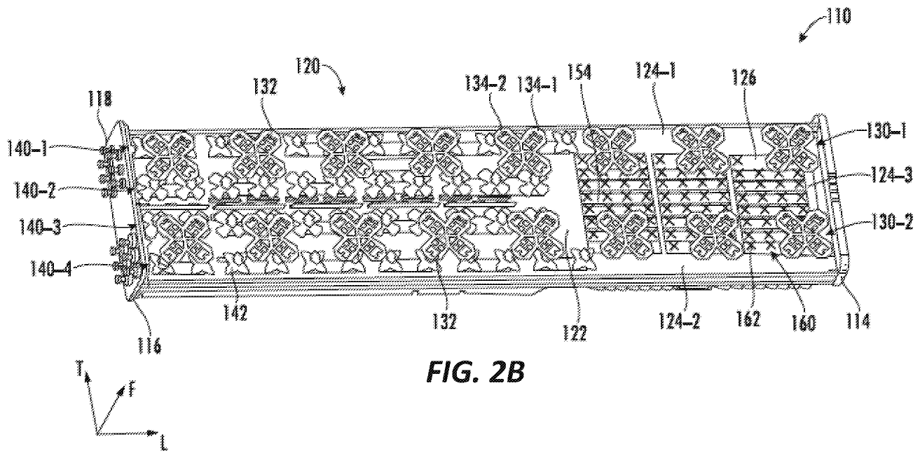

FIGS. 2A-2B illustrate a conventional passive/active antenna system 100 that includes both a passive base station antenna 110 and an active antenna module 150. In particular, FIG. 2A is a schematic rear perspective view of the passive/active antenna system 100, while FIG. 2B is a schematic perspective view of the passive/active antenna system 100 of FIG. 2A with radomes of both the passive base station antenna 110 and the active antenna module omitted. In FIGS. 2A and 2B, the axes illustrate the longitudinal (L), transverse (T) and forward (F) directions of the base station antenna system 100. In the description that follows, the antenna 100 and the radiating elements included therein will be described using terms that assume that the antenna 100 is mounted for normal use on a tower with a longitudinal axis of the antenna 100 extending along a vertical axis and the front surface of the antenna 100 mounted opposite the tower pointing toward the coverage area for the antenna 100.

Referring to FIG. 2A, the passive/active antenna system 100 may be mounted, for example, on an antenna tower 102 using mounting hardware 104. The active antenna module 150 may be mounted directly on a rear surface of the passive base station antenna 110, or may be held in place behind the passive base station antenna 110 by the mounting hardware 104. The front surface of the passive/active antenna system 100 may be opposite the antenna tower 102 facing toward a coverage area of the passive/active antenna system 100. The passive base station antenna 110 includes a tubular radome 112 that surrounds and protects an antenna assembly that is mounted inside the radome 112. A top end cap 114 covers a top opening in the radome 112 and a bottom end cap 116 covers a bottom opening in the radome 112. A plurality of RF ports 118 extend through the bottom end cap 116 and are used to connect the passive base station antenna 110 to one or more external radios (not shown). The active antenna module 150 may be removably mounted behind the passive base station antenna 110 so that the active antenna module 150 may later be replaced with a different active antenna module.

Referring to FIG. 2B, the passive base station antenna 110 includes a reflector assembly 120. The reflector assembly 120 may be referred to herein as a “passive reflector assembly” since it is part of the passive base station antenna 110. The passive reflector assembly 120 includes a main reflector 122 and spaced-apart first and second reflector strips 124-1, 124-2 that extend longitudinally from respective first and second opposed sides of the main reflector 122. The passive reflector assembly 120 may further include a third reflector strip 124-3 that extends in a transverse direction between top ends of the first and second reflector strips 124-1, 124-2. An opening 126 is defined between the first and second reflector strips 124-1, 124-2. For example, the opening 126 may be bounded by a top portion of the main reflector 122, the first and second reflector strips 124-1, 124-2, and the third reflector strip 124-3. At least the main reflector 122 may comprise or include a metallic surface (e.g., a sheet of aluminium) that serves as a reflector and ground plane for the radiating elements of the antenna 100. Various mechanical and electronic components of the antenna (not shown) may be mounted behind the passive reflector assembly 120 such as, for example, phase shifters, remote electronic tilt units, mechanical linkages, controllers, diplexers, and the like.

The passive base station antenna 110 further includes a plurality of passive linear arrays of radiating elements that extend forwardly from the passive reflector assembly 120. The linear arrays may support, for example, 2G, 3G and/or 4G cellular service. In the example passive base station antenna 110 shown in FIGS. 2A-2B, the linear arrays include first and second low-band linear arrays 130-1, 130-2 that are configured to operate in all or part of the 617-960 MHz frequency band. Each low-band linear array 130 comprises a vertically-extending column of low-band radiating elements 132. The passive base station antenna 110 further includes first through fourth mid-band linear arrays 140-1 through 140-4 that are configured to operate in all or part of the 1427-2690 MHz frequency band. Each mid-band linear array 140 comprises a vertically-extending column of mid-band radiating elements 142. Each of the low-band and mid-band linear arrays 130, 140 may generate relatively static antenna beams that provide coverage to a predefined coverage area (e.g., antenna beams that are each configured to cover a sector of a base station), with the only change to the coverage area occurring when the electronic downtilt angles of the generated antenna beams are adjusted (e.g., to change the size of the cell).

Each of the low-band and mid-band radiating elements 132, 142 may be implemented as dual-polarized radiating elements that include first and second radiators that transmit and receive RF energy at orthogonal polarizations. When such dual-polarized radiating elements are used, each of the low-band and mid-band linear arrays 130, 140 may be connected to a pair of the RF ports 118. The first RF port 118 is connected between a first port of a radio (e.g., a remote radio head mounted on the antenna tower 102 near the passive base station antenna 110) and the first polarization radiators of the radiating elements in one of the linear arrays, and the second RF port 118 is connected between a second port of a radio and the second polarization radiators of the radiating elements in the linear array. RF signals that are to be transmitted by a selected one of the linear arrays 130, 140 are passed from the radio to one of the RF ports 118, and passed from the RF port 118 to a power divider (or, alternatively, a phase shifter assembly that includes a power divider) that divides the RF signal into a plurality of sub-components that are fed to the respective first or second radiators of the radiating elements in the linear array, where the sub-components of the RF signal are radiated into free space.

The low-band and/or mid-band radiating elements 132, 142 may be mounted on feed board printed circuit boards that couple RF signals to and from the individual radiating elements 132, 142. In FIG. 2B, the mid-band radiating elements 142 are shown as being mounted in pairs on a plurality of mid-band feed board printed circuit boards 148 (the low-band radiating elements are likewise mounted on feed board printed circuit boards but they are not visible in the figure). Cables may be used to connect each feed board printed circuit board 148 to other components of the antenna such as diplexers, phase shifters or the like.

Most of the low-band and mid-band radiating elements 132, 142 are mounted to extend forwardly from the main reflector 122. However, low-band linear arrays 130-1, 130-2 extend substantially the full length of the passive/active antenna system 100 and hence extend beyond the main reflector 122. The first and second reflector strips 124-1, 124-2 may provide mounting locations for low-band radiating elements 132 that are positioned above the main reflector 122. The first and second reflector strips 124-1, 124-2 may be integral with the main reflector 122 so that the first and second reflector strips 124-1, 124-2 and the main reflector 122 will be maintained at a common ground voltage, which may improve the performance of the low-band linear arrays 130-1, 130-2.

Each low-band radiating element 132 may comprise a slant −45°/+45° cross-dipole radiating element that includes a slant −45° polarization dipole radiator 134-1 and a slant +45° polarization dipole radiator 134-2. The dipole radiators 134-1, 134-2 may be mounted on a feed stalk (not shown). In some cases, the three uppermost low-band radiating elements 132 that are above the main reflector 122 may be mounted on a frequency selective surface (“FSS”) that covers the opening 126. This FSS is described in further detail below. In other cases, the low-band radiating elements 132 may include tilted feed stalks that allow these radiating elements to be mounted on the first and second reflector strips 124-1, 124-2 while the dipole arms of these radiating elements are in front of the opening 126. Each low-band radiating element 132 has dipole arms that are designed to be substantially transparent to RF energy emitted by the mid-band radiating elements 142.

The active antenna module 150 includes a multi-column beamforming array 160 of radiating elements 162 and a beamforming radio (not visible in the figures). The multi-column beamforming array 160 may be mounted in a forward portion of the active antenna module 150, and the beamforming radio may be mounted behind the multi-column beamforming array 160. The beamforming array 160 may, for example, comprise a plurality of vertically-extending columns of high-band radiating elements 162 that are configured to operate in all or part of the 3.1-4.2 GHz frequency band. The high-band radiating elements 162 are mounted to extend forwardly from a reflector 154 of the active antenna module 150 (herein the “active reflector”). The beamforming radio is capable of electronically adjusting the amplitude and/or phase of the subcomponents of an RF signal that are output to different radiating elements 162 of the multi-column beamforming array 160. For example, each port of the beamforming radio may be coupled to a column of radiating elements of the beamforming array 160, and the amplitudes and phases of the sub-components of the RF signals that are fed to each column may be adjusted so that the generated antenna beams are narrowed in the azimuth plane and pointed in a desired direction in the azimuth plane.

The beamforming array 160 of active antenna module 150 is mounted behind the opening 126 in the passive reflector assembly 114. The beamforming array 160 is visible in FIG. 2B as the radomes of the passive base station antenna 110 and the active antenna module 150 are omitted in the view of FIG. 2B. The opening 126 in the passive reflector assembly 120 allows the antenna beams generated by the beamforming array 160 to pass through the passive base station antenna 110 to provide service to the coverage area of the passive/active antenna system 100.

An FSS (not shown) may cover the opening 126. The FSS may be configured to allow RF energy emitted by the high band radiating elements 162 in the beamforming array 160 to pass therethrough, while the FSS reflects RF energy in lower frequency bands (and specifically, low-band RF signals that are emitted by the low-band radiating elements 132. The FSS may be coplanar with the opening 126, in front of the opening 126 or behind the opening 126. The FSS can have a grid pattern such as a grid of metal patches and/or other metal structures. The grid pattern can be arranged in any suitable manner and may be symmetric or asymmetric across a width and/or length of the FSS. The grid pattern may comprise sub-wavelength periodic microstructures. The metal patches/structures may be arranged in one or more layers. The FSS may be formed on a substrate such as, for example, a printed circuit board or of sheet metal. In some embodiments, the FSS may comprise a portion of the passive reflector assembly 120 that is stamped to form the metal grid structure therein. In such cases, the “opening 126” comprises a large number of small openings that act as a large opening with respect to RF energy in the operating frequency band of the beamforming array 160.

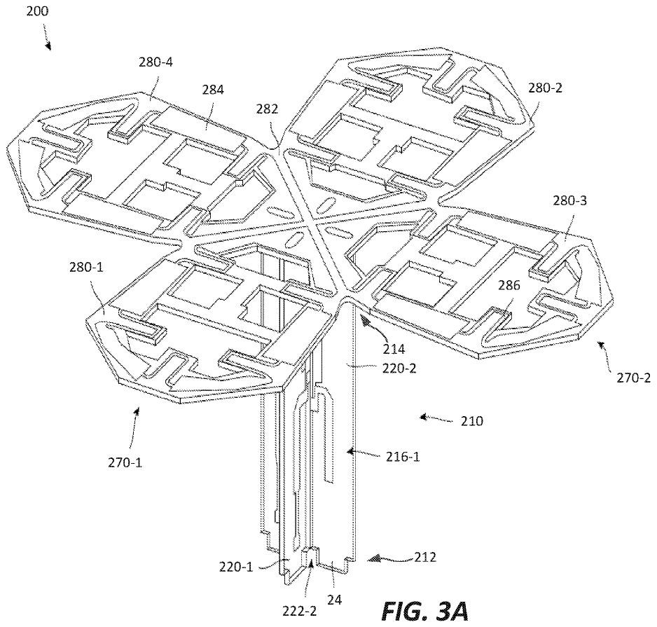

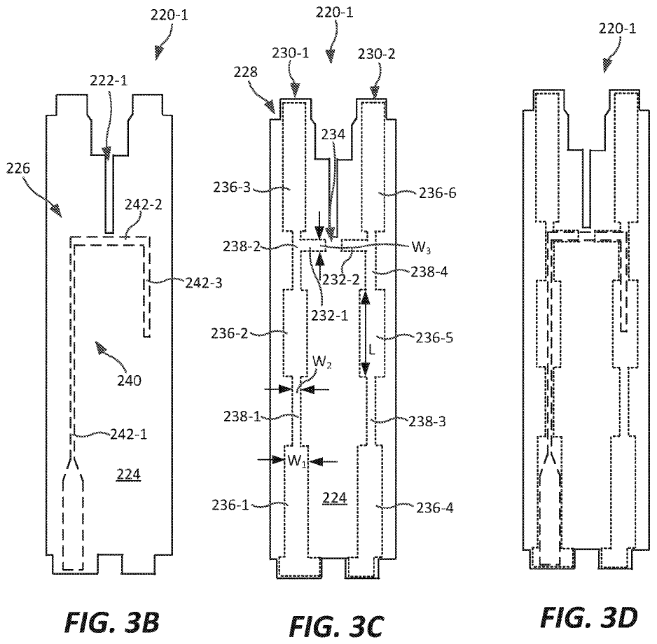

Embodiments of the present invention will now be described in further detail with reference to FIGS. 3A-5.

FIG. 3A is a perspective view of a low-band radiating element 200 according to embodiments of the present invention. FIGS. 3B and 3C are plan views of the first and second sides of a first feed stalk printed circuit board 220-1 included in radiating element 200, while FIG. 3D is a shadow plan view that illustrates the metallization on both sides of the dielectric substrate of the first feed stalk printed circuit board 220-1. In FIGS. 3B-3D, the solid lines illustrate the outline of the dielectric substrate of the first feed stalk printed circuit board 220-1, the dashed lines illustrate the metallization patterns on the first side of feed stalk printed circuit board 220-1, and the dotted lines illustrate the metallization patterns on the second side of feed stalk printed circuit board 220-1. Low-band radiating element 200 may, for example, be used to implement the low-band radiating elements 132 of base station antenna 100.

Referring to FIG. 3A, low-band radiating element 200 includes a feed stalk 210, a first dipole radiator 270-1, and a second dipole radiator 270-2. The first dipole radiator 270-1 includes first and second dipole arms 280-1, 280-2, and the second dipole radiator 270-2 includes third and fourth dipole arms 280-3, 280-4. The dipole radiators 270-1, 270-2 of radiating element 200 are positioned adjacent a forward end of the feed stalk 210 and may be (and typically are) physically mounted on the distal end of the feed stalk 210. The dipole radiators 270 and dipole arms 280 may be identical to the dipole radiators 70 and dipole arms 80 described above with reference to FIGS. 1A-1B, and hence further description thereof will be omitted here.

The feed stalk 210 has a base 212 and a distal (forward) end 214 that is positioned forwardly of the base 212. The feed stalk 210 comprises first and second feed stalk printed circuit boards 220-1, 220-2. The first feed stalk printed circuit board 220-1 includes a slit 222-1 (see FIG. 3B) that extends rearwardly from the distal end base 214 of the feed stalk 210, and the second feed stalk printed circuit board 220-2 includes a slit 222-2 that extends forwardly from the base 212 of the feed stalk 210. Feed stalk printed circuit boards 220-1 and 220-2 are arranged perpendicular to each other with the slit 222-2 in feed stalk printed circuit board 220-2 received within the slit 222-1 in feed stalk printed circuit board 220-1 so that the two mated printed circuit boards 210-1, 210-2 have a cross-shape when viewed from the front.

The first feed stalk printed circuit board 220-1 comprises a dielectric substrate 224 that has a first metallization layer 226 on one main surface of the dielectric substrate 224 and a second metallization layer 228 on the other main surface of the dielectric substrate 224. FIGS. 3B and 3C are plan views of the two main surfaces of the dielectric substrate 224.

Referring to FIG. 3B, the first metallization layer 226 that is formed on the first main surface of the dielectric substrate 224 comprises a signal trace 240. The signal trace 240 is coupled to the signal conductor of the feed transmission line that feeds feed stalk printed circuit board 220-1, typically at the base of the feed stalk 210. The signal trace 240 extends forwardly from the base of the first feed stalk printed circuit board 220-1 and travels about two-thirds of the way toward the distal end of the first feed stalk printed circuit board 220-1. The signal trace 240 includes a forwardly extending segment 242-1, a transversely extending segment 242-2, and a rearwardly extending segment 242-3. The forwardly extending segment 242-1 comprises a widened pad region near the base of the first feed stalk printed circuit board 220-1 and a narrower trace that extends forwardly from the widened pad region. The transversely extending segment 242-2 comprises a narrow trace that extends from the end of the forwardly extending segment 242-1 to cross over a gap 234 (discussed below) between the first and second ground lines 230-1, 230-2. The rearwardly extending segment 242-3 comprises a narrow trace that extends at a right angle from the end of the transversely extending segment 242-2 toward the base 212 of feed stalk 210.

Referring to FIG. 3C, the second metallization layer 228 that is formed on the second main surface of the dielectric substrate 224 comprises first and second ground lines 230-1, 230-2. Each ground line 230 extends substantially from the base to the distal end of the first feed stalk printed circuit board 220-1. The end of each ground line 230 that is at the base of the first feed stalk printed circuit board 220-1 may be coupled to the ground conductor (not shown) of the first feed transmission line for radiating element 200. As shown the ground lines 230 may have widened pad regions at the base of the first feed stalk printed circuit board 220-1 to facilitate connecting the ground conductor of the first feed transmission line for radiating element 200 to the ground lines 230.

Each of the first and second ground lines 230-1, 230-2 includes a respective inwardly extending protrusion 232-1, 232-2. A distal end of the first protrusion 232-1 thus faces a distal end of the second protrusion 232-2. A small gap 234 where no metallization is formed separates the protrusions 232-1, 232-2. The protrusions 232-1, 232-2 are positioned just rearwardly of the slit 222-1.

The first and second ground lines 230-1, 230-2 may each have a length of about ¼ of the center wavelength of radiating element 200.

Each ground line 230 may comprise a plurality of widened conductive segments 236 that are connected by one or more narrowed conductive traces 238. In the depicted embodiment, each ground line 230 includes three widened conductive segments 236 and two narrowed conductive traces 238. On the first ground line 230-1, narrowed conductive trace 238-1 connects widened conductive segment 236-1 to widened conductive segment 236-2, and narrowed conductive trace 238-2 connects widened conductive segment 236-2 to widened conductive segment 236-3. On the second ground line 230-2, narrowed conductive trace 238-3 connects widened conductive segment 236-4 to widened conductive segment 236-5, and narrowed conductive trace 238-4 connects widened conductive segment 236-5 to widened conductive segment 236-6.

Each widened conductive section 236 has a respective width W₁, where the width W₁ is measured in a direction that is generally perpendicular to the direction of current flow along the respective widened section 236. The width W₁ of each widened section 236 need not be constant, and hence in some instances reference will be made to the average width of each widened section 236. The narrowed conductive traces 238 may similarly have a respective width W₂, where the width W₂ is measured in a direction that is generally perpendicular to the direction of current flow along the narrowed conductive traces 238. The width W₂ of each narrowed conductive trace 238 also need not be constant, and hence in some instances reference will be made to the average width of each narrowed trace section 238. The average width W₁ of each widened conductive section 236 may be, for example, at least twice the average width W₂ of each narrowed conductive trace 238 in some embodiments. In other embodiments, the average width W₁ of each widened conductive section 236 may be at least three times the average width W₂ of each narrowed conductive trace 238.

Each narrowed conductive trace 238 may act as high impedance element that is designed to interrupt currents in the higher-band frequency range that could otherwise be induced on the ground lines 230. The narrowed conductive traces 238 may be designed to create this high impedance for higher-band currents without significantly impacting the ability of the low-band currents to flow on the feed stalk 210. As such, the narrowed conductive traces 238 may reduce induced high-band currents on the feed stalks 210 of the low-band radiating elements 200 and consequent disturbance to the antenna pattern of the higher-band linear arrays. In some embodiments, the narrowed conductive traces 238 may make the feed stalks 210 of the low-band radiating elements 200 almost invisible to the higher-band radiating elements.

The first protrusion 232-1 extends inwardly from the second narrowed conductive trace 238-2 and the second protrusion 232-2 extends inwardly from the fourth narrowed conductive trace 238-4. The first and second protrusions 232-1, 232-2 may each comprise narrowed conductive traces that are open-circuited at their respective distal ends.

Referring to FIG. 3D, it can be seen that the forwardly extending segment 242-1 of the signal trace 240 overlaps the first ground line 230-1. The transversely extending segment 242-2 of the signal trace 240 overlaps portions of both the first ground line 230-1 and the second ground line 230-2. The rearwardly extending segment 342-3 of the signal trace 240 overlaps the second ground line 330-2.

The second feed stalk printed circuit board 220-2 (see FIG. 3A) is almost identical to printed circuit board 220-1, with the differences being (1) the location of the slits 222-1, 222-2 and (2) on feed stalk printed circuit board 220-2 the transversely extending segment 242-2 is closer to the base 212 of the feed stalk 210 to allow this segment to cross over an axis defined by the slit 222-2 in the forward portion of feed stalk printed circuit board 220-2. Thus, further description of the second feed stalk printed circuit board 220-2 will be omitted here.

As shown in FIGS. 3A-3D, radiating element 200 includes a feed stalk 210 that has a base 212 and a distal end 214 that is positioned forwardly of the base 212. Radiating element 200 further includes first and second dipole radiators 270-1, 270-2 that are mounted at the distal end 214 of the feed stalk 210, the first dipole radiator 270-1 including a first dipole arm 280-1 and a second dipole arm 280-2, and the second dipole radiator 270-2 including a third dipole arm 280-3 and a fourth dipole arm 280-4. The feed stalk 210 includes a first ground line 230-1 and a first signal trace 240 that at least partially overlaps the first ground line 230-1. Here, the first ground line 230-1 and a first signal trace 240 are each formed on a first feed stalk printed circuit board 220-1. The first ground line 230-1 comprises first, second and third widened conductive segments 236-1, 236-2, 236-3, where the first and second widened conductive segments 236-1, 236-2 are connected by a first narrowed conductive trace 238-1 and the second and third widened conductive segments 236-2, 236-3 are connected by a second narrowed conductive trace 238-2.

The feed stalk printed circuit board 220-1 further includes a second ground line 230-2 that comprises at least fourth, fifth and sixth widened conductive segments 236-4, 236-5, 236-6, where the fourth and fifth widened conductive segments 236-4, 236-5 are connected by a third narrowed conductive trace 238-3 and the fifth and sixth widened conductive segments 236-5, 236-6 are connected by a fourth narrowed conductive trace 238-4. The first ground line 230-1 extends forwardly along substantially an entire length of the feed stalk 210. The first ground line 230-1 includes a first spur in the form of a first protrusion 232-1 that extends toward the second ground line 230-2. The second ground line 230-2 extends forwardly along substantially the entire length of the feed stalk 210, and similarly includes a second spur in the form of a second protrusion 232-2 that extends toward the first ground line 230-1. The first spur 232-1 extends from the second narrowed conductive trace 238-2, and the second spur 232-2 extends from the fourth narrowed conductive trace 238-4.

The first narrowed conductive trace 238-1 has an average width of W₂ and the first widened conductive segment 236-1 has an average width of W₁. W₂ is less than half W₁. An average width W₃ of the first spur 232-1 is less than the average width W₁ of the first widened conductive segment 236-1. An average width W₃ of the second spur 232-2 is less than an average width W₁ of the fourth widened conductive segment 236-4, and the second spur 232-2 extends from the fourth narrowed conductive trace 238-4. The first through third widened conductive segments 236-1, 236-2, 236-3 may have respective lengths L that vary by less than 25%. The fourth through sixth widened conductive segments 236-4, 236-5, 236-6 may also have respective lengths L that vary by less than 25%. In some embodiments, the lengths L of the first through sixth widened conductive segments 236-1 through 236-6 may vary by less than 25%. In some embodiments, the average widths W₁ of the first through sixth widened conductive segments 236-1 through 236-6 may vary by less than 15%.

The first signal trace 240 fully overlaps the first narrowed conductive trace 238-1 and fully overlaps the second narrowed conductive trace 238-2.

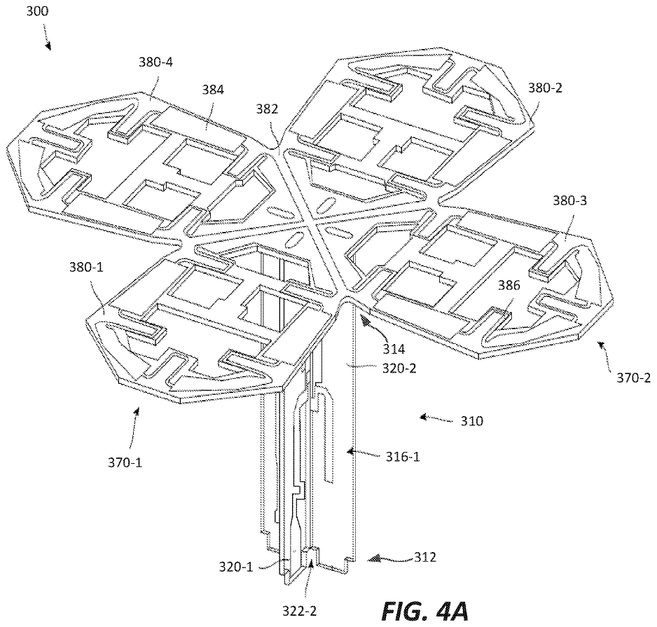

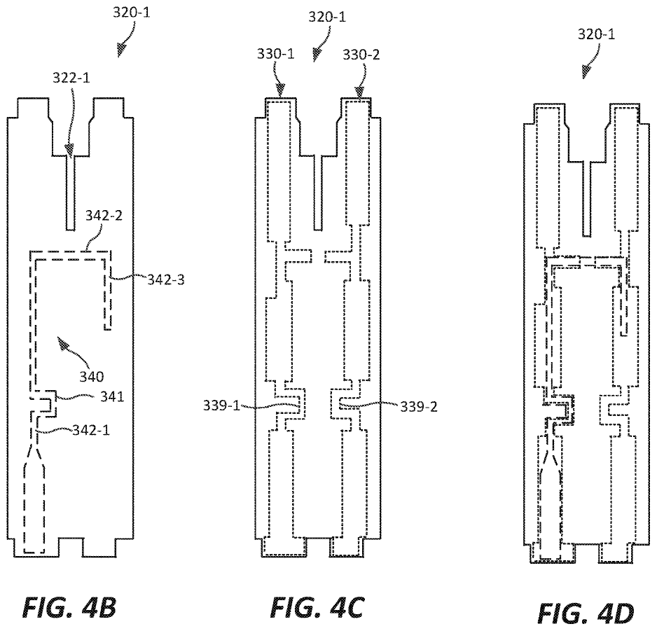

FIG. 4A is a perspective view of a low-band radiating element 300 according to embodiments of the present invention side view. FIGS. 4B and 4C are plan views of the first and second sides of a first feed stalk printed circuit board 320-1 included in radiating element 300, while FIG. 4D is a shadow plan view that illustrates the metallization on both sides of the dielectric substrate of the first feed stalk printed circuit board 220-1. In FIGS. 4B-4D, the solid lines illustrate the outline of the dielectric substrate of the first feed stalk printed circuit board 320-1, the dashed lines illustrate the metallization patterns on the first side of the first feed stalk printed circuit board 320-1, and the dotted lines illustrate the metallization patterns on the second side of the first feed stalk printed circuit board 320-1. Low-band radiating element 300 may, for example, be used to implement the low-band radiating elements 132 of passive base station antenna 110. As low-band radiating 300 is very similar to low-band radiating element 200, the description below will focus on the differences between the two radiating elements 200, 300.

As can be seen by comparing FIGS. 3B-3D to FIGS. 4B-4D, the first feed stalk printed circuit board 320-1 is almost identical to the first feed stalk printed circuit board 220-1, with the only difference being that the signal trace 340 (which includes sections 342-1, 342-2, 342-3) on the first feed stalk printed circuit board 320-1 includes a meandered section 341 and that and one of the narrowed conductive traces on each of the ground lines 330-1, 330-2 on the first feed stalk printed circuit board 320-1 likewise is implemented as a meandered narrowed conductive trace section 339-1, 339-2. Herein, a meandered section of a conductive trace refers to a non-linear section of the conductive trace that follows a meandered path to increase the path length thereof. Including meandered sections on conductive traces provides a convenient way to extend the length of the conductive trace while still providing a relatively compact conductive trace.

As shown in FIG. 3C, the meandered section 341 of the signal trace 340 is implemented by including a generally U-shaped section in the signal trace 340. The generally U-shaped section may have square corners, rounded corners, corners with one or more angled or beveled regions, etc. Similarly, the meandered section 339 of each ground line 330-1, 330-2 is implemented by including a generally U-shaped section in the ground line 330. It will also be appreciated that the meandered sections 341, 339 may be implemented to have a series of U-shaped sections that form a square wave, a sine wave or the like, or may include multiple spaced apart U-shaped sections. It will likewise be appreciated that the meander may be formed using other than generally U-shaped sections in other embodiments.

The meandered sections 341, 339 act to increase the overall inductance of the signal trace 340 and the first and second ground lines 330-1, 330-2. The added inductance in the signal trace 340 may help to further suppress formation of higher-band currents on the signal trace 340. In addition, the meandered section 341 allows the signal trace to completely overlap the first ground line 330-1 (which has a similar meandered section 339) so that the first signal trace 340 will be formed as a microstrip transmission line along its entire length with the exception of the small portion of the signal trace 340 that is over the gap 334 that separates the first and second protrusions 332-1, 332-2 of the respective first and second ground lines 330-1, 330-2. The added inductance in the ground lines 330, coupled with the edge capacitances between the widened conductive sections 336, may create an LC circuit that acts like a filter to suppress formation of higher-band currents on the ground lines 330.

It will also be appreciated that some radiating elements are formed using sheet metal or die cast feed stalks as opposed to printed circuit based feed stalks. Any of the techniques disclosed herein may be implemented in such sheet metal or die cast based feed stalks.

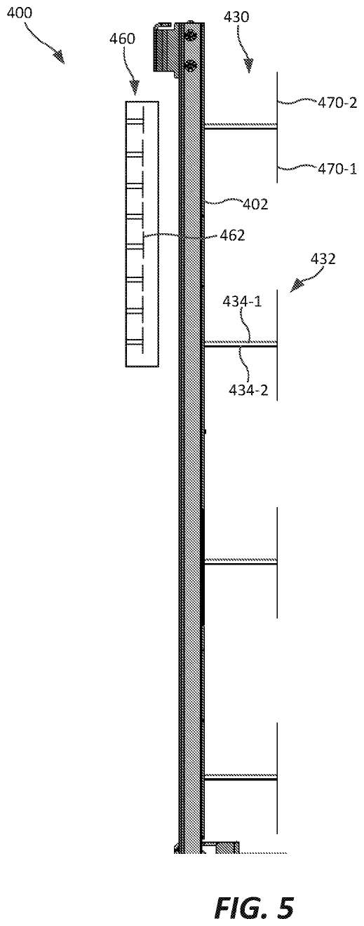

FIG. 5 is a schematic side view of a base station antenna 400 that includes low-band radiating elements 432 according to further embodiments of the present invention. The base station antenna 400 may be identical to the base station antenna 100 described above (even though all of the elements of base station antenna 100 are not shown in FIG. 5 in order to simplify the drawing). The base station antenna 400 includes a frequency selective surface 402, an array 430 of lower-band radiating elements 432, at least some of which are positioned forwardly of the frequency selective surface 402, and a multi-column array 460 of higher-band radiating elements 462 that are positioned rearwardly of the frequency selective surface 402. At least one of the lower-band radiating elements 432 includes a pair of dipole radiators 470-1, 470-2, a first feed cable 434-1 and a second feed cable 434-2. The first feed cable 434-1 and the second feed cable 434-2 each extend forwardly from the frequency selective surface 402 to directly attach to the respective first and second dipole radiators 470-1, 470-2. The dipole radiators 470-1, 470-2 may be implemented using the dipole radiator printed circuit board 82 of radiating element 1. The first and second feed cables 434-1, 434-2 may be implemented, for example, using RG405 cables, which are very thin coaxial cables. The coaxial cables 434-1, 434-2 may each have a diameter of less than 1.68 mm.

One difficulty with the passive/active base station antenna system 100 of FIGS. 2A-2B is that the low-band radiating elements 132 are mounted directly in front of the high-band beamforming array 160. As such, metal elements of the low-band radiating elements 132 may partially block/reflect the RF radiation emitted by the high-band beamforming array 160 and/or the high-band RF radiation may induce current on metal elements of the low-band radiating elements 132 that then reradiate the high-band radiation in ways that act to distort the shape of the antenna beams generated by the high-band beamforming array 160. By using very thin coaxial cables 434-1, 434-2 to feed the low-band radiating elements 132 the impact of the low-band radiating elements 132 on the antenna beams generated by the high-band beamforming array 160 may be reduced in some case.

While the dipole arms of the low-band radiating elements described above are implemented in dipole radiator printed circuit boards, it will be appreciated that embodiments of the present invention are not limited thereto. For example, in other embodiments, the dipole arms may be implemented as sheet metal dipole arms or using other metal structures.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

Herein, the term “substantially” means within +/−10%.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A cross-dipole radiating element, comprising:
a feed stalk having a base and a distal end that is positioned forwardly of the base;
a first dipole radiator mounted at the distal end of the feed stalk, the first dipole radiator including a first dipole arm and a second dipole arm; and
a second dipole radiator mounted at the distal end of the feed stalk, the second dipole radiator including a third dipole arm and a fourth dipole arm,
wherein the feed stalk includes a first ground line and a first signal trace that at least partially overlaps the first ground line,
wherein the first ground line comprises at least first, second and third widened conductive segments, where the first and second widened conductive segments are connected by a first narrowed conductive trace and the second and third widened conductive segments are connected by a second narrowed conductive trace.

2. The cross-dipole radiating element of claim 1, wherein an average width of the first narrowed conductive trace is less than half an average width of the first widened conductive segment.

3. The cross-dipole radiating element of claim 2, the feed stalk further comprising a second ground line that comprises at least fourth, fifth and sixth widened conductive segments, where the fourth and fifth widened conductive segments are connected by a third narrowed conductive trace and the fifth and sixth widened conductive segments are connected by a fourth narrowed conductive trace.

4. The cross-dipole radiating element of claim 3, wherein the first ground line extends forwardly along substantially an entire length of the feed stalk, the first ground line further comprising a first spur that extends toward the second ground line, and the second ground line extends forwardly along substantially the entire length of the feed stalk, the second ground line further comprising a second spur that extends toward the first ground line.

5. (canceled)

6. The cross-dipole radiating element of claim 4, wherein the first spur extends from the second narrowed conductive trace.

7-9. (canceled)

10. The cross-dipole radiating element of claim 1, wherein the first single trace includes a first forwardly extending segment, a second transversely extending segment and a third rearwardly extending segment, wherein one of the first forwardly extending segment, the second transversely extending segment and the third rearwardly extending segment includes a meandered section.

11. The cross-dipole radiating element of claim 10, wherein the first forwardly extending segment includes the meandered section.

12. The cross-dipole radiating element of claim 1, wherein the first narrowed conductive trace includes a meandered section.

13. (canceled)

14. A cross-dipole radiating element, comprising:
a feed stalk having a base and a distal end that is positioned forwardly of the base;
a first dipole radiator mounted at the distal end of the feed stalk, the first dipole radiator including a first dipole arm and a second dipole arm; and
a second dipole radiator mounted at the distal end of the feed stalk, the second dipole radiator including a third dipole arm and a fourth dipole arm,
wherein the feed stalk includes a first ground line and a first signal trace,
wherein the first signal trace comprises a first forwardly extending segment, a second transversely extending segment and a third segment, and
wherein one of the first forwardly extending segment, the second transversely extending segment and the third segment includes a meandered section.

15. (canceled)

16. The cross-dipole radiating element of claim 14, wherein the first forwardly extending segment includes the meandered section.

17. The cross-dipole radiating element of claim 14, wherein the first ground line comprises first and second widened conductive segments that are connected by a first narrowed conductive trace.

18. The cross-dipole radiating element of claim 17, wherein an average width of the first narrowed conductive trace is less than half an average width of the first widened conductive segment.

19. The cross-dipole radiating element of claim 18, wherein the first narrowed conductive trace includes a meandered section.

20. The cross-dipole radiating element of claim 14, wherein the first signal trace fully overlaps the first narrowed conductive.

21-24. (canceled)

25. A cross-dipole radiating element, comprising:
a feed stalk having a base and a distal end that is positioned forwardly of the base;
a first dipole radiator mounted at the distal end of the feed stalk, the first dipole radiator including a first dipole arm and a second dipole arm; and
a second dipole radiator mounted at the distal end of the feed stalk, the second dipole radiator including a third dipole arm and a fourth dipole arm,
wherein the feed stalk includes a first ground line and a first signal trace,
wherein the first ground line includes first and second widened conductive segments that are connected by a first narrowed conductive trace that includes a first meandered section.

26. The cross-dipole radiating element of claim 25, wherein the first meandered section comprises a U-shaped section.

27. The cross-dipole radiating element of claim 25, wherein an average width of the first narrowed conductive trace is less than half an average width of the first widened conductive segment.

28. The cross-dipole radiating element of claim 25, wherein the first signal trace includes a first forwardly extending segment, a second transversely extending segment and a third rearwardly extending segment, wherein one of the first forwardly extending segment, the second transversely extending segment and the third rearwardly extending segment includes a second meandered section.

29. The cross-dipole radiating element of claim 28, wherein the first forwardly extending segment includes the second meandered section.

30. The cross-dipole radiating element of claim 25, the feed stalk further comprising a second ground line that comprises at least third and fourth widened conductive segments that are connected by a second narrowed conductive trace.

31-36. (canceled)
